(19) United States
(12) Patent Application Publication
(10) Pub. No.: US 2018/0228203 A1
(43) Pub. Date: Aug. 16, 2018

(54) PRE-VAPOR FORMULATION FOR FORMATION OF ORGANIC ACIDS DURING OPERATION OF AN E-VAPING DEVICE

(71) Applicant: Altria Client Services LLC, Richmond, VA (US)

(72) Inventors: Yezdi B. PITHAWALLA, Midlothian, VA (US); Niti H. SHAH, Henrico, VA (US); Adam N. ANDERSON, Moseley, VA (US)

(73) Assignee: Altria Client Services LLC, Richmond, VA (US)

(21) Appl. No.: 15/434,195

(22) Filed: Feb. 16, 2017

(51) Int. Cl. A24B 15/16; C07B 41/08

(52) U.S. Cl. CPC A24B 15/167; C07B 41/08

(57) ABSTRACT

A pre-vapor formulation of an e-vaping device including a vapor former, nicotine, sugars or polysaccharide carbohydrates, an oxidant, and a base. A method of increasing stability of ingredients of a pre-vapor formulation includes mixing a vapor former, nicotine, sugars and/or polysaccharide carbohydrates, an oxidant and an added base, catalyzing a reaction between the sugars or polysaccharide carbohydrates, the oxidant and the base, and generating acids via a reaction therebetween, wherein a concentration of the nicotine in a vapor phase of the vapor is equal to or smaller than substantially 1% by weight.

### BACKGROUND

### Field

Example embodiments relate generally to a pre-vapor formulation for an e-vaping device configured to control the acidity in the e-vaping device via in-situ generation of one or more organic acids during operation of the e-vaping device.

### Related Art

Electronic vaping devices (or e-vaping devices) are used to vaporize a pre-vapor formulation such as, for example, a liquid material, into a vapor to be consumed by an adult vaper. E-vaping devices may include a heater that is configured to vaporize the pre-vapor formulation to produce the vapor, a power source, a cartridge or e-vaping tank including the heater, and a reservoir holding the pre-vapor formulation. The power supply section includes a power source such as a battery, and the cartridge includes the heater along with the reservoir housing the pre-vapor formulation in liquid or gel form. The heater may be in contact with the pre-vapor formulation via a wick, the pre-vapor formulation being stored in the reservoir, and the heater being configured to heat the pre-vapor formulation via the wick to produce a vapor. For example, the pre-vapor formulation may include a liquid, solid and/or gel formulation including, but not limited to, water, beads, solvents, active ingredients, ethanol, plant extracts, natural or artificial flavors, and/or vapor formers such as glycerine and/or propylene glycol.

A cigarette produces a vapor known to create a desired sensory experience for an adult smoker, including a low to moderate harshness response and a perceived warmth or strength. With respect to e-vaping devices, the harshness of the vapor, which is typically understood as the sensation experienced in the throat of an adult vaper, and the strength of the vapor, which is typically understood as the sensation experienced in the chest of the adult vaper, may vary based on the contents and concentrations of the pre-vapor formulation used to form the vapor. For example, the concentration of nicotine in the vapor resulting from operation of the e-vaping device may have an effect on the perceived harshness and/or strength of the e-vaping device.

For a similar amount of nicotine as in a cigarette, an e-vaping device may deliver more nicotine in the vapor phase to the adult vaper than a cigarette may deliver in the vapor phase to an adult smoker, which increases the harshness of the vapor and may diminish the sensory experience of the adult vaper as a result of the increased harshness. The fraction of nicotine in the vapor phase may contribute to perceptions of throat harshness and/or other perceived off-tastes. Reducing the proportional level of nicotine in the gas phase may improve the perceived subjective deficits associated with nicotine in the gas phase. Acids may be added to the pre-vapor formulation to reduce the amount of nicotine present in the vapor phase generated by the e-vaping device. However, a level of acid in the pre-vapor formulation that is too high may also degrade the taste of the vapor, or may decrease of the stability of the ingredients.

In addition, over the shelf life of an e-vaping device, the ingredients may react with other ingredients, which may render the pre-vapor formulation less stable and less suitable for proper use in an e-vaping device. For example, various ingredients of the pre-vapor formulation may react with dissolved oxygen present in the liquid formulation, or with ambient oxygen, to undergo oxidation.

### SUMMARY OF THE INVENTION

The pre-vapor formulation of an e-vaping device is configured to form a vapor having a particulate phase and a gas phase when heated by the heater in the e-vaping device. In example embodiments, the pre-vapor formulation includes nicotine, water, propylene glycol, glycerol or a mixture of propylene glycol and glycerol, a combination of sugars and/or polysaccharide carbohydrates, an oxidant, an added base, and substantially no organic acids. The pre-vapor formulation may also include flavorants and/or aromas.

In at least one example embodiment, the oxidant may include a metal oxide. For example, the oxidant may include copper oxide, zinc oxide, iron oxide, and the like.

At least one example embodiment relates to a pre-vapor formulation that includes sugars or polysaccharide carbohydrates in the form of at least one of fructose, glucose, galactose, maltose and xylose. For example, the sugars or polysaccharide carbohydrates concentration may be in the range of about 1% to about 30% by weight, of about 1% to about 10% by weight, or of about 1% to about 5% by weight.

At least one example embodiment relates to a pre-vapor formulation that includes polysaccharide carbohydrates in the form of starch, cellulose and pectin in a concentration of, for example, about 1-10% by weight.

At least one example embodiment relates to an e-vaping device configured to generate one or more organic acids during operation of the e-vaping device, the one or more organic acids being absent from the pre-vapor formulation prior to operation of the e-vaping device. In example embodiments, during operation of the e-vaping device, one or more acids, such as organic acids, are generated by the reaction of a combination of sugars and/or polysaccharide carbohydrates with the oxidant. As a result of the generation of the one or more organic acids, a decrease in the harshness and/or an increase of the strength of the vapor generated during operation of the e-vaping device may occur. Accordingly, the sensory experience of the adult vaper is improved.

At least one example embodiment relates to an e-vaping device that is configured to generate one or more organic acids during operation of the e-vaping device, the generated organic acids decreasing the levels of harshness in the throat and perceived strength in the chest of the adult vaper, and thus provide a perceived sensory experience for adult vapers that is comparable to the sensory experience of a cigarette.

Another example embodiment relates to an e-vaping device that is configured to provide a sensory experience, including levels of harshness in the throat and perceived strength or warmth in the chest that are similar to those experienced when smoking a tobacco-based product. In achieving a desirable balance of strength and harshness, the strength of the e-vaping product may be increased without increasing the harshness thereof.

In at least one example embodiment, a pre-vapor formulation of an e-vaping device includes a mixture of a vapor former, optionally water, nicotine and various combinations of sugars and/or polysaccharide carbohydrates. The various combinations of sugars and/or polysaccharide carbohydrates may result, via one or more chemical reactions with the sugars and/or polysaccharide carbohydrates, in the generation of acids of varying strengths, resulting in varying degrees of influence on the reduction of nicotine in the vapor. In example embodiments, the generated acids may be organic acids.

In at least one example embodiment, during operation of the e-vaping device, a dynamic equilibrium typically exists between dissociated and non-dissociated acid molecules in the pre-vapor formulation, the acid molecules being generated via reaction of the acids with the sugars and/or polysaccharide carbohydrates, the protonated and the non-protonated nicotine molecules. The respective concentrations of the protonated and the non-protonated nicotine molecules typically depends on the strength of the generated acid (or acids) and of the respective concentrations of the generated acid (or acids) and nicotine.

During operation of the e-vaping device according to various example embodiments, when the pre-vapor formulation is heated by the heater, the combination of sugars and/or polysaccharide carbohydrates reacts with the oxidant and/or an added base of the pre-vapor formulation, under hydrothermal conditions, to form one or more organic acids. The added base included in the pre-vapor formulation may include, for example, sodium hydroxide, acetone, ammonia, calcium hydroxide, lithium hydroxide, potassium hydroxide, pyridine, and zinc hydroxide. After the elements of the formulation are vaporized during heating, upon subsequent cooling, the elements of the formulation condense to form a vapor. The increased presence of nicotine in protonated form, due to the presence of the acid or acids generated during operation of the e-vaping device, substantially locks the nicotine in the particulate phase of the heated pre-vapor formulation and reduces the availability of nicotine to the gas phase of the vapor. As a result of the lower content of nicotine in the gas phase, the amount of perceived throat harshness by an adult vaper is reduced. In various embodiments, the acid combination generated by chemical reaction during operation of the e-vaping device reduces gas phase nicotine by forming a nicotine salt, and thereby reduces transfer efficiency of the nicotine from the particulate phase to the gas phase. As a result of the lower content of nicotine in the gas phase, the amount of perceived throat harshness by an adult vaper may be reduced. However, the amount of nicotine in the gas phase remains sufficient to provide the adult vaper with a satisfactory vaping experience.

In at least one example embodiment, the pre-vapor formulation includes a mixture of a vapor former and water in a ratio of, for example, about 85/15, nicotine in an amount of, for example, up to 4.5% by weight, about 1% to about 30% sugar, about 1-5% of polysaccharide carbohydrate, about 1-3% of an oxidant such as, for example, CuO, and about 2% of an added base such as, for example, sodium hydroxide, acetone, ammonia, calcium hydroxide, lithium hydroxide, potassium hydroxide, pyridine, and zinc hydroxide. The vapor former may include, for example, 60/40 glycerol/propylene glycol. In example embodiments, the oxidant includes a metal oxide such as, for example, copper oxide, zinc oxide, iron oxide, and the like. In example embodiments, the added base includes at least one of sodium hydroxide, acetone, ammonia, calcium hydroxide, lithium hydroxide, potassium hydroxide, pyridine, and zinc hydroxide.

In at least one example embodiment, the one or more organic acids generated during operation of the e-vaping device by chemical reaction between the combination of sugars and/or polysaccharide carbohydrates may have a liquid to vapor transfer efficiency of about 50% or greater, and may be generated in an amount sufficient to reduce the nicotine gas phase element by about 70% by weight or greater compared to the nicotine in the particulate phase. In other embodiments, the one or more acids are generated in an amount that is sufficient to reduce the nicotine gas phase element by about 40% to about 70% by weight. For example, the concentration of the acid is between substantially 0.25% by weight and substantially 2% by weight. In at least one example embodiment, a concentration of nicotine in the gas phase is equal to or smaller than substantially 1% by weight of the gas phase.

In at least one example embodiment, a method of reducing perceived throat harshness of a vaporized formulation of an e-vaping device includes generating one or more acids during operation of the e-vaping device by chemical reaction between a combination of sugars and/or polysaccharide carbohydrates and an oxidant, in an amount sufficient to reduce the perceived throat harshness by an adult vaper without degrading the taste of the vapor.

In at least one example embodiment, the acids generated by chemical reaction of the combination of sugars and/or polysaccharide carbohydrates during operation of the e-vaping device include at least one of formic acid, oxalic acid, glycolic acid, acetic acid, isovaleric acid, valeric acid, propionic acid, octanoic acid, lactic acid, sorbic acid, malic acid, tartaric acid, succinic acid, citric acid, benzoic acid, oleic acid, aconitic acid, butyric acid, cinnamic acid, decanoic acid, 3,7-dimethyl-6-octenoic acid, 1-glutamic acid, heptanoic acid, hexanoic acid, 3-hexenoic acid, trans-2-hexenoic acid, isobutyric acid, lauric acid, 2-methylbutyric acid, 2-methylvaleric acid, myristic acid, nonanoic acid, palmitic acid, 4-pentenoic acid, phenylacetic acid, 3-phenylpropionic acid, hydrochloric acid, phosphoric acid and sulfuric acid.

In at least one example embodiment, the respective concentrations of sugars and/or polysaccharide carbohydrates in the pre-vapor formulation may be such that the concentration of the acids generated by the reaction with the combination of sugars and/or polysaccharide carbohydrates during operation of the e-vaping device is between substantially 0.25% by weight and substantially 2% by weight. The reaction between the respective concentrations of sugars and/or polysaccharide carbohydrates and the oxidant may be such that the concentration of the generated acids may also be between substantially 0.5% by weight and substantially 1.5% by weight, or between substantially 1.5% by weight and substantially 2% by weight. The reaction between the respective sugars and/or polysaccharide carbohydrates and the oxidant may be such that the combination of the generated acids may include between 1 and 10 acids. For example, the reaction between the respective sugars and/or polysaccharide carbohydrates and the oxidant may be such that the combination of generated acids may include 3 acids. The respective concentrations of sugars and/or polysaccharide carbohydrates may be such that the combination of acids generated via the reaction between the sugars and/or polysaccharide carbohydrates and the oxidant includes substantially equal parts of each individual acid included in the combination. For example, the combination of generated acids may include substantially equal parts of tartaric acid and acetic acid.

In at least one example embodiment, the concentration of the nicotine in the pre-vapor formulation is between substantially 1.5% by weight and substantially 6% by weight. The concentration of the nicotine in the pre-vapor formulation may also be between substantially 3% by weight and substantially 5% by weight. However, in example embodiments, the concentration of the nicotine in the gas phase of the vapor, during operation of the e-vaping device when organic acids are generated via the reaction with the sugars and/or polysaccharide carbohydrates, may be less than about 1.5%. In example embodiments, the concentration of the nicotine in the gas phase of the vapor is about 2% or less, about 1%, about 0.5% or about 0.1%.

In at least one example embodiment, the pre-vapor formulation includes substantially 3% nicotine by weight. In at least one example embodiment, the pre-vapor formulation includes substantially 3% to 5% nicotine by weight.

In at least one example embodiment, the respective concentrations of sugars and/or polysaccharide carbohydrates may result in a combination of tartaric acid and acetic acid. The tartaric acid and acetic acid generated via the reaction with the sugars and/or polysaccharide carbohydrates may be in equal proportions. In addition, the resulting vapor generated during operation of the e-vaping device may include an amount of nicotine in the gas phase that is less than or equal to substantially 1% of the gas phase by weight. The above combination of the tartaric acid and acetic acid, together with the nicotine concentration in the gas phase of the vapor of equal to or less than substantially 1% of the total nicotine delivered, results in a vapor that has a combination of warmth in the chest and higher concentrations of nicotine in the gas phase without a substantial increase in harshness with the resulting degradation of the taste experienced by the adult vaper.

In at least one example embodiment, the temperature ranges at which acid is generated as discussed above are about 150° C. to about 350° C. or about 250° C. to about 325° C.

In various example embodiments, the respective concentrations of sugars and/or polysaccharide carbohydrates may result in a stabilization of vapor pH, an improvement of the sensory experience of the adult vaper with respect to harshness, a reduction in nicotine in the gas phase, and an improvement in the performance of the e-vaping device by reducing undesired deposits that may form inside the e-vaping device without increasing the acidity of the resulting vapor to a level that may degrade the taste of the vapor. The undesired deposits may form by reaction of organic acids present in the pre-vapor formulation when the e-vaping is not in operation.

### BRIEF DESCRIPTION OF THE DRAWINGS

The above and other features and advantages of example embodiments will become more apparent by describing in detail, example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 is a side view of an e-vaping device, according to an example embodiment;

FIG. 2 is a longitudinal cross-sectional view of an e-vaping device, according to an example embodiment;

FIG. 3 is a longitudinal cross-sectional view of another example embodiment of an e-vaping device;

FIG. 4 is a longitudinal cross-sectional view of another example embodiment of an e-vaping device; and

FIG. 5 is a flow chart illustrating a method of increasing stability of the ingredients of a pre-vapor formulation of an e-vaping device, according to various example embodiments.

### DETAILED DESCRIPTION

Some detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It should be understood that when an element or layer is referred to as being “on,” “connected to,” “coupled to,” or “covering” another element or layer, it may be directly on, connected to, coupled to, or covering the other element or layer or intervening elements or layers may be present. In contrast, when an element is referred to as being “directly on,” “directly connected to,” or “directly coupled to” another element or layer, there are no intervening elements or layers present. Like numbers refer to like elements throughout the specification. As used herein, the term “and/or” includes any and all combinations of one or more of the associated listed items.

It should be understood that, although the terms “first,” “second,” “third,” etc. may be used herein to describe various elements, regions, layers and/or sections, these elements, regions, layers, and/or sections should not be limited by these terms. These terms are only used to distinguish one element, region, layer, or section from another region, layer, or section. Thus, a first element, region, layer, or section discussed below could be termed a second element, region, layer, or section without departing from the teachings of example embodiments.

Spatially relative terms (e.g., “beneath,” “below,” “lower,” “above,” “upper,” and the like) may be used herein for ease of description to describe one element or feature's relationship to another element(s) or feature(s) as illustrated in the figures. It should be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various embodiments only and is not intended to be limiting of example embodiments. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations and/or elements, but do not preclude the presence or addition of one or more other features, integers, steps, operations, elements and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the shapes of regions illustrated herein but are to include deviations in shapes that result, for example, from manufacturing. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

When the terms “about” or “substantially” are used in this specification in connection with a numerical value, it is intended that the associated numerical value include a tolerance of ±10% around the stated numerical value. Moreover, when reference is made to percentages in this specification, it is intended that those percentages are based on weight, i.e., weight percentages. The expression “up to” includes amounts of zero to the expressed upper limit and all values therebetween. When ranges are specified, the range includes all values therebetween such as increments of 0.1%.

As used herein, the term “vapor former” describes any suitable known compound or mixture of compounds that, in use, facilitates formation of a vapor and that is substantially resistant to thermal degradation at the operating temperature of the e-vaping device. Suitable vapor-formers consist of various compositions of polyhydric alcohols such as propylene glycol and/or glycerol or glycerin. In at least one embodiment, the vapor former is propylene glycol.

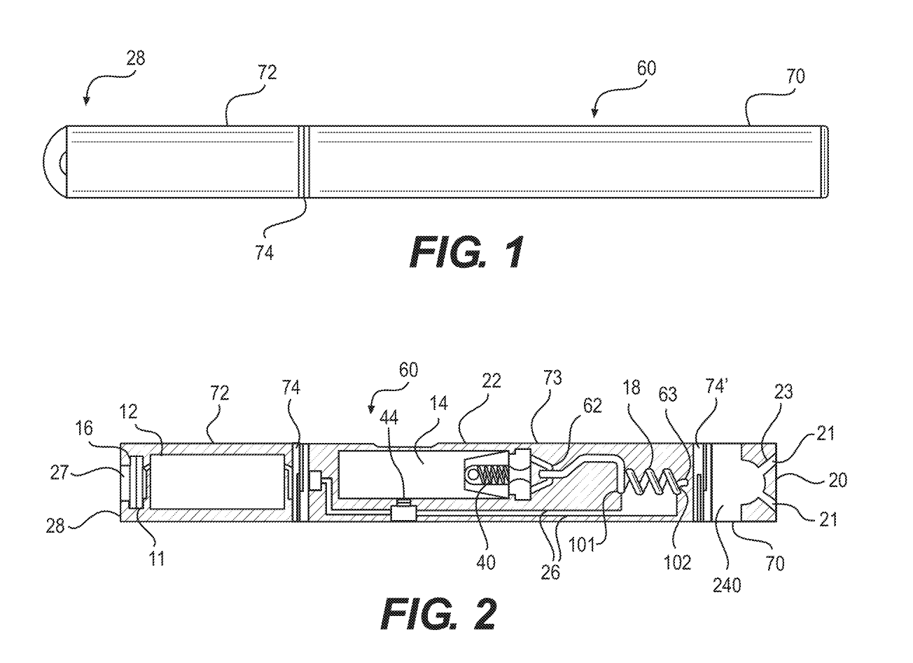

FIG. 1 is a side view of an e-vaping device 60, according to an example embodiment. In FIG. 1, the e-vaping device 60 includes a first section or cartridge 70 and a second section 72 or power supply section 72, which are coupled together at a threaded joint 74 or by other connecting structure such as a snug-fit, snap-fit, detent, clamp and/or clasp or the like. In at least one example embodiment, the first section or cartridge 70 may be a replaceable cartridge, and the second section 72 may be a reusable section. Alternatively, the first section or cartridge 70 and the second section 72 may be integrally formed in one piece. In at least one embodiment, the second section 72 includes a LED at a distal end 28 thereof. In example embodiments, the first section may be or include a tank 70 configured to hold the pre-vapor formulation and to be manually refillable.

FIG. 2 is a cross-sectional view of an example embodiment of an e-vaping device. As shown in FIG. 2, the first section or cartridge 70 can house a mouth-end insert 20, a capillary tube 18, and a reservoir 14.

In example embodiments, the reservoir 14 may include a wrapping of gauze about an inner tube (not shown). For example, the reservoir 14 may be formed of or include an outer wrapping of gauze surrounding an inner wrapping of gauze. In at least one example embodiment, the reservoir 14 may be formed of or include an alumina ceramic in the form of loose particles, loose fibers, or woven or nonwoven fibers. Alternatively, the reservoir 14 may be formed of or include a cellulosic material such as cotton or gauze material, or a polymer material, such as polyethylene terephthalate, in the form of a bundle of loose fibers. A more detailed description of the reservoir 14 is provided below.

The second section 72 can house a power supply 12, control circuitry 11 configured to control the power supply 12, and a puff sensor or draw sensor 16. The puff sensor 16 is configured to sense when an adult vaper is drawing on the e-vaping device 60, which triggers operation of the power supply 12 via the control circuitry 11 to heat the pre-vapor formulation housed in the reservoir 14, and thereby form a vapor. A threaded portion 74 of the second section 72 can be connected to a battery charger, when not connected to the first section or cartridge 70, to charge the battery or power supply section 12.

In example embodiments, the capillary tube 18 is formed of or includes a conductive material, and thus may be configured to be its own heater by passing current through the tube 18. The capillary tube 18 may be any electrically conductive material capable of being heated, for example resistively heated, while retaining the necessary structural integrity at the operating temperatures experienced by the capillary tube 18, and which is non-reactive with the pre-vapor formulation. Suitable materials for forming the capillary tube 18 are one or more of stainless steel, copper, copper alloys, porous ceramic materials coated with film resistive material, nickel-chromium alloys, and combinations thereof. For example, the capillary tube 18 is a stainless steel capillary tube 18 and serves as a heater via electrical leads 26 attached thereto for passage of direct or alternating current along a length of the capillary tube 18. Thus, the stainless steel capillary tube 18 is heated by, for example, resistance heating. Alternatively, the capillary tube 18 may be a non-metallic tube such as, for example, a glass tube. In such an embodiment, the capillary tube 18 also includes a conductive material such as, for example, stainless steel, nichrome or platinum wire, arranged along the glass tube and capable of being heated, for example resistively. When the conductive material arranged along the glass tube is heated, pre-vapor formulation present in the capillary tube 18 is heated to a temperature sufficient to at least partially volatilize pre-vapor formulation in the capillary tube 18.

In at least one embodiment, the electrical leads 26 are bonded to the metallic portion of the capillary tube 18. In at least one embodiment, one electrical lead 26 is coupled to a first, upstream portion 101 of the capillary tube 18 and a second electrical lead 26 is coupled to a downstream, end portion 102 of the capillary tube 18.

In operation, when an adult vaper draws on the e-vaping device, the puff sensor 16 detects a pressure gradient caused by the negative pressure, and the control circuitry 11 controls heating of the pre-vapor formulation located in the reservoir 14 by providing power to the capillary tube 18. Once the capillary tube 18 is heated, the pre-vapor formulation contained within a heated portion of the capillary tube 18 is volatilized and emitted from the outlet 63, where the pre-vapor formulation expands and mixes with air and forms a vapor in mixing chamber 240.

As shown in FIG. 2, the reservoir 14 includes a valve 40 configured to maintain the pre-vapor formulation within the reservoir 14 and to open when the reservoir 14 is squeezed and pressure is applied thereto, the pressure being created when an adult vaper draws on the e-vaping device at the mouth-end insert 20, which results in the reservoir 14 forcing the pre-vapor formulation through the outlet 62 of the reservoir 14 to the capillary tube 18. In at least one embodiment, the valve 40 opens when a critical, minimum pressure is reached so as to avoid inadvertently dispensing pre-vapor formulation from the reservoir 14. In at least one embodiment, the pressure required to press the pressure switch 44 is high enough such that accidental heating due to the pressure switch 44 being inadvertently pressed by outside factors such as physical movement or collision with outside objects is avoided.

The power supply 12 of example embodiments can include a battery arranged in the second section 72 of the e-vaping device 60. The power supply 12 is configured to apply a voltage to volatilize the pre-vapor formulation housed in the reservoir 14.

In at least one embodiment, the electrical connection between the capillary tube 18 and the electrical leads 26 is substantially conductive and temperature resistant while the capillary tube 18 is substantially resistive so that heat generation occurs primarily along the capillary tube 18 and not at the contacts.

The power supply section or battery 12 may be rechargeable and include circuitry allowing the battery to be chargeable by an external charging device. In example embodiments, the circuitry, when charged, provides power for a given number of draws through outlets of the e-vaping device, after which the circuitry may have to be re-connected to an external charging device.

In at least one embodiment, the e-vaping device 60 may include control circuitry 11 which can be, for example, on a printed circuit board. The control circuitry 11 may also include a heater activation light 27 that is configured to glow when the device is activated. In at least one embodiment, the heater activation light 27 comprises at least one LED and is at a distal end 28 of the e-vaping device 60 so that the heater activation light 27 illuminates a cap which takes on the appearance of a burning coal when the adult vaper draws on the e-vaping device. Moreover, the heater activation light 27 can be configured to be visible to the adult vaper. The light 27 may also be configured such that the adult vaper can activate and/or deactivate the light 27 when desired, such that the light 27 is not activated during vaping if desired.

In at least one embodiment, the e-vaping device 60 further includes a mouth-end insert 20 having at least two off-axis, diverging outlets 21 that are uniformly distributed around the mouth-end insert 20 so as to substantially uniformly distribute vapor in the mouth of an adult vaper during operation of the e-vaping device. In at least one embodiment, the mouth-end insert 20 includes at least two diverging outlets 21 (e.g., 3 to 8 outlets or more). In at least one embodiment, the outlets 21 of the mouth-end insert 20 are located at ends of off-axis passages 23 and are angled outwardly in relation to the longitudinal direction of the e-vaping device 60 (e.g., divergently). As used herein, the term “off-axis” denotes an angle to the longitudinal direction of the e-vaping device.

In at least one embodiment, the e-vaping device 60 is about the same size as a tobacco-based cigarette. In some embodiments, the e-vaping device 60 may be about 80 mm to about 110 mm long, for example about 80 mm to about 100 mm long and about 7 mm to about 10 mm in diameter.

The outer cylindrical housing 22 of the e-vaping device 60 may be formed of or include any suitable material or combination of materials. In at least one embodiment, the outer cylindrical housing 22 is formed at least partially of metal and is part of the electrical circuit connecting the control circuitry 11, the power supply 12 and the puff sensor 16.

As shown in FIG. 2, the e-vaping device 60 can also include a middle section (third section) 73, which can house the pre-vapor formulation reservoir 14 and the capillary tube 18. The middle section 73 can be configured to be fitted with a threaded joint 74′ at an upstream end of the first section or cartridge 70 and a threaded joint 74 at a downstream end of the second section 72. In this example embodiment, the first section or cartridge 70 houses the mouth-end insert 20, while the second section 72 houses the power supply 12 and the control circuitry 11 that is configured to control the power supply 12.

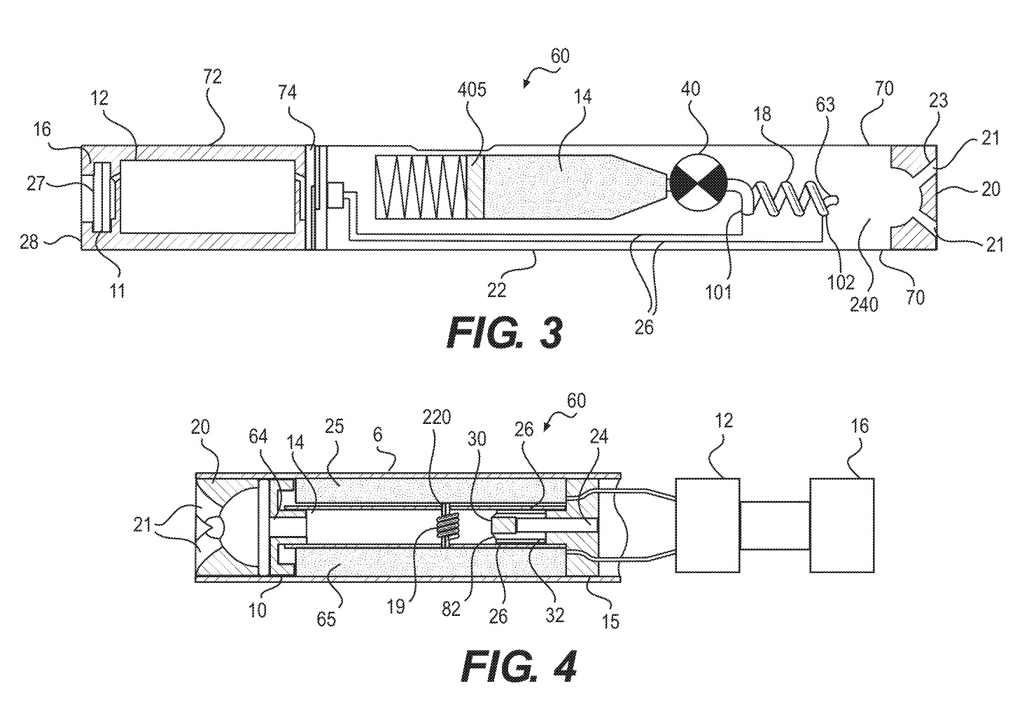

FIG. 3 is a cross-sectional view of an e-vaping device according to an example embodiment. In at least one embodiment, the first section or cartridge 70 is replaceable so as to avoid the need for cleaning the capillary tube 18. In at least one embodiment, the first section or cartridge 70 and the second section 72 may be integrally formed without threaded connections to form a disposable e-vaping device.

As shown in FIG. 3, in other example embodiments, a valve 40 can be a two-way valve, and the reservoir 14 can be pressurized. For example, the reservoir 14 can be pressurized using a pressurization arrangement 405 configured to apply constant pressure to the reservoir 14. As such, emission of vapor formed via heating of the pre-vapor formulation housed in the reservoir 14 is facilitated. Once pressure upon the reservoir 14 is relieved, the valve 40 closes and the heated capillary tube 18 discharges any pre-vapor formulation remaining downstream of the valve 40.

FIG. 4 is a longitudinal cross-sectional view of another example embodiment of an e-vaping device. In FIG. 4, the e-vaping device 60 can include a central air passage 24 in an upstream seal 15. The central air passage 24 opens to the inner tube 65. Moreover, the e-vaping device 60 includes a reservoir 14 configured to store the pre-vapor formulation. The reservoir 14 includes the pre-vapor formulation and optionally a storage medium 25 such as gauze configured to store the pre-vapor formulation therein. In an embodiment, the reservoir 14 is contained in an outer annulus between the outer tube 6 and the inner tube 65. The annulus is sealed at an upstream end by the seal 15 and by a stopper 10 at a downstream end so as to prevent leakage of the pre-vapor formulation from the reservoir 14. The heater 19 at least partially surrounds a central portion of a wick 220 such that when the heater is activated, the pre-vapor formulation present in the central portion of the wick 220 is vaporized to form a vapor. The heater 19 is connected to the battery 12 by two spaced apart electrical leads 26. The e-vaping device 60 further includes a mouth-end insert 20 having at least two outlets 21. The mouth-end insert 20 is in fluid communication with the central air passage 24 via the interior of inner tube 65 and a central passage 64, which extends through the stopper 10.

The e-vaping device 60 may include an air flow diverter comprising an impervious plug 30 at a downstream end 82 of the central air passage 24 in seal 15. In at least one example embodiment, the central air passage 24 is an axially extending central passage in seal 15, which seals the upstream end of the annulus between the outer and inner tubes 6, 65. The radial air channel 32 directing air from the central passage 20 outward toward the inner tube 65. In operation, when an adult vaper draws on the e-vaping device, the puff sensor 16 detects a pressure gradient, and activates control circuitry 11 that controls heating of the pre-vapor formulation located in the reservoir 14 by providing power to the heater 19.

In an example embodiment, the pre-vapor formulation includes a mixture of nicotine, water, propylene glycol and/or glycerol, a combination of sugars and/or polysaccharide carbohydrates, an oxidant, an added base, and substantially no organic acids. During operation of the e-vaping device, the sugars and/or polysaccharide carbohydrates react with the oxidant and the added base to generate one or more acids. The acids, for example organic acids, typically protonate the molecular nicotine in the pre-vapor formulation, so that upon heating of the pre-vapor formulation by a heater during operation of the e-vaping device, a vapor having a majority amount of protonated nicotine and a minority amount of unprotonated nicotine is produced, whereby only a minor portion of all the volatilized (vaporized) nicotine typically remains in the gas phase of the vapor. For example, although the pre-vapor formulation may include up to 5% of nicotine, the proportion of nicotine in the gas phase of the vapor may be substantially 1% or less.

In some example embodiments, the amount of sugars and/or polysaccharide carbohydrates as well as oxidant and added base to be added to the pre-vapor formulation may depend on the desired strength and volatility of the acid generated as a result, and of the amount of generated acid needed to adjust the pH of the pre-vapor formulation to the desired range. If too much acid is generated as a result of the chemical reaction between the combination of sugars and/or polysaccharide carbohydrates and the oxidant during operation of the e-vaping device, most or substantially all of the available nicotine may be protonated and enter the particulate phase of the vapor, leaving little or substantially no unprotonated nicotine in the gas phase of the vapor, and thus generating a vapor with not enough harshness to satisfy the taste expectations of an adult vaper. In contrast, if too little acid or an ineffective (weak) acid is generated as a result of the chemical reaction between the combination of sugars and/or polysaccharide carbohydrates and the oxidant during operation of the e-vaping device, a larger amount of nicotine may remain unprotonated and remain in the gas phase of the vapor so that the adult vaper may experience increased and possibly undesirable throat harshness. For example, the pH of the pre-vapor formulation is between about 4 and about 6.

With pre-vapor formulations having a nicotine content above approximately 2% by weight, and in the absence of one or more acids, the perceived throat harshness may approach levels which render the vapor unpleasant to the adult vaper. With pre-vapor formulations of nicotine content above approximately 4% by weight, and in the absence of one or more acids, perceived throat harshness may approach levels rendering the vapor unacceptable to the adult vaper. With the generation of one or more acids from the reaction between sugars and/or polysaccharide carbohydrates, an oxidant and an added base during operation of the e-vaping device according to the teachings herein, perceived throat harshness may be maintained at desirable levels, akin to the throat harshness experienced with tobacco-based products.

According to at least one example embodiment, the acids generated as a result of the chemical reaction between the combination of sugars and/or polysaccharide carbohydrates and the oxidant during operation of the e-vaping device have the ability to transfer into the vapor. Transfer efficiency of an acid is the ratio of the mass fraction of the acid in the vapor to the mass fraction of the acid in the liquid or pre-vapor formulation. In at least one example embodiment, the acid or combination of acids generated during operation of the e-vaping device have a liquid to vapor transfer efficiency of about 50% or greater, and for example about 60% or greater. For example, tartaric acid and acetic acid, generated from the reaction between the combination of sugars and/or polysaccharide carbohydrates, at least one oxidant and at least one added base during operation of the e-vaping device, have vapor transfer efficiencies of about 50% or greater.

In at least one example embodiment, the acid(s) generated during operation of the e-vaping device are generated in an amount sufficient to reduce the amount of nicotine gas phase element by about 30% by weight or greater, by about 60% to about 70% by weight, by about 70% by weight or greater, or by about 85% by weight or greater, of the level of nicotine gas phase element produced by an equivalent pre-vapor formulation that does not include the acid(s).

According to at least one example embodiment, the acid(s) generated during operation of the e-vaping device include one or more of formic acid, oxalic acid, glycolic acid, acetic acid, isovaleric acid, valeric acid, propionic acid, octanoic acid, lactic acid, sorbic acid, malic acid, tartaric acid, succinic acid, citric acid, benzoic acid, oleic acid, aconitic acid, butyric acid, cinnamic acid, decanoic acid, 3,7-dimethyl-6-octenoic acid, 1-glutamic acid, heptanoic acid, hexanoic acid, 3-hexenoic acid, trans-2-hexenoic acid, isobutyric acid, lauric acid, 2-methylbutyric acid, 2-methylvaleric acid, myristic acid, nonanoic acid, palmitic acid, 4-pentenoic acid, phenylacetic acid, 3-phenylpropionic acid, hydrochloric acid, phosphoric acid, sulfuric acid, and combinations thereof. The pre-vapor formulation may also include a vapor former, optionally water, and optionally flavorants.

In at least one example embodiment, the vapor former is one of propylene glycol, glycerin and combinations thereof. In another example embodiment, the vapor former is substantially only glycerin. In at least one example embodiment, the vapor former is included in an amount ranging from about 40% by weight based on the weight of the pre-vapor formulation to about 90% by weight based on the weight of the pre-vapor formulation (e.g., about 50% to about 80%, about 55% to about 75% or about 60% to about 70%). Moreover, in at least one example embodiment, the pre-vapor formulation can include propylene glycol and glycerin included in a ratio of about 3:2. In at least one example embodiment, the ratio of propylene glycol and glycerin may be substantially 2:3 and 3:7.

The pre-vapor formulation optionally includes water. Water can be included in an amount ranging from about 5% by weight based on the weight of the pre-vapor formulation to about 40% by weight based on the weight of the pre-vapor formulation, or in an amount ranging from about 10% by weight based on the weight of the pre-vapor formulation to about 15% by weight based on the weight of the pre-vapor formulation.

The acid(s) generated during operation of the e-vaping device may have a boiling point of at least about 100° C. For example, the generated acid(s) may have a boiling point ranging from about 100° C. to about 300° C., or about 150° C. to about 250° C. (e.g., about 160° C. to about 240° C., about 170° C. to about 230° C., about 180° C. to about 220° C. or about 190° C. to about 210° C.). By generating acids having a boiling point within the above ranges, the acids may volatilize when heated by the heater element of the e-vaping device. In at least one example embodiment utilizing a heater coil and a wick, the heater coil may reach an operating temperature of about 300° C.

The total content of acid generated from the reaction between the combination of sugars and/or polysaccharide carbohydrates, at least one oxidant and at least one added base during operation of the e-vaping device in the pre-vapor formulation may range from about 0.1% by weight to about 6% by weight, or from about 0.1% by weight to about 2% by weight, based on the weight of the pre-vapor formulation. The pre-vapor formulation may also contain between up to 3% and 5% nicotine by weight. In at least one example embodiment, the total generated acid content of the pre-vapor formulation during operation of the e-vaping device is less than about 3% by weight. In another example embodiment, the total generated acid content of the pre-vapor formulation during operation of the e-vaping device is less than about 0.5% by weight. The pre-vapor formulation may also contain between about 4.5% and 5% nicotine by weight. When tartaric acid and/or acetic acid is generated during operation of the e-vaping device, the total generated acid content of the pre-vapor formulation may be about 0.05% by weight to about 2% by weight, or about 0.1% by weight to about 1% by weight.

In at least one example embodiment, tartaric acid may be generated in the pre-vapor formulation in an amount ranging from about 0.1% by weight to about 5.0% by weight, and for example about 0.4% by weight. Acetic acid may be generated in an amount ranging from about 0.1% by weight to about 5.0% by weight. In at least one example embodiment, the entire generated acid content of the pre-vapor formulation is less than about 3% by weight.

Furthermore, the concentrations and types of generated acids may be adjusted to maintain the desired low levels of gas phase nicotine, even at the more elevated nicotine content levels in the pre-vapor formulation.

In example embodiments, the total generated acid content of the pre-vapor formulation may range from about 0.1% by weight to about 6% by weight, such as from about 0.5% to about 4% by weight, or from about 1% to about 3% by weight, or from about 1.5% to about 2.5% by weight, or from about 0.1% by weight to about 2% by weight. For example, in embodiments, the total generated acid content of the pre-vapor formulation may be from about 0.5% to about 2.5%, such as from about 1.5% to about 2.0% by weight based on the total weight of the pre-vapor formulation, where the pre-vapor formulation may contain from about 2% to about 5% nicotine, such as from about 2.5% to about 4.5% nicotine.

In example embodiments, tartaric acid is generated in an amount ranging from about 0.1 to about 2% by weight based on the weight of the pre-vapor formulation, and acetic acid is generated in an amount ranging from about 0.1 to about 2% by weight based on the weight of the pre-vapor formulation. In embodiments, a combination of tartaric and acetic acid is generated in the pre-vapor formulation in a total amount from about 0.1 to about 2% by weight based on the weight of the pre-vapor formulation, such as from about 1.5% to about 2% by weight. In example embodiments, tartaric and acetic acid are each generated, for example in approximately equal amounts (equal by weight percent of the pre-vapor formulation). The formulation may contain nicotine in an amount ranging from about 2% by weight to about 10% by weight, such as from about 2% to about 9%, or from about 2% to about 8%, or from about 2% to about 6%, or from about 2% to about 5%. For example, in example embodiments, the formulation may contain nicotine in an amount from about 2.5% to about 4.5% based on the total weight of the pre-vapor formulation. The formulation may also include nicotine bitartrate in concentrations ranging from about 0.5% to about 1.5%.

The pre-vapor formulation may also include a flavorant in an amount ranging from about 0.01% to about 15% by weight (e.g., about 1% to about 12%, about 2% to about 10%, or about 5% to about 8%). The flavorant can be a natural flavorant or an artificial flavorant. In at least one example embodiment, the flavorant is one of tobacco flavor, menthol, wintergreen, peppermint, herb flavors, fruit flavors, nut flavors, liquor flavors, and combinations thereof.

In example embodiments, the nicotine is included in the pre-vapor formulation in an amount ranging from about 2% by weight to about 6% by weight (e.g., about 2% to about 3%, about 2% to about 4%, about 2% to about 5%) based on the total weight of the pre-vapor formulation. In at least one example embodiment, the nicotine is added in an amount of up to about 5% by weight based on the total weight of the pre-vapor formulation. In at least one example embodiment, the nicotine content of the pre-vapor formulation is about 2% by weight or greater based on the total weight of the pre-vapor formulation. In another example embodiment, the nicotine content of the pre-vapor formulation is about 2.5% by weight or greater based on the total weight of the pre-vapor formulation. In another example embodiment, the nicotine content of the pre-vapor formulation is about 3% by weight or greater based on the total weight of the pre-vapor formulation. In another example embodiment, the nicotine content of the pre-vapor formulation is about 4% by weight or greater based on the total weight of the pre-vapor formulation. In another example embodiment, the nicotine content of the pre-vapor formulation is about 4.5% by weight or greater based on the total weight of the pre-vapor formulation.

By providing a pre-vapor formulation comprising nicotine at concentrations greater than 2% or more by weight, for example in the range of 2% to about 6% by weight, together with the generated acids to the pre-vapor formulation in accordance with the example embodiments, the perceived sensory benefits for the adult vaper associated with the higher nicotine levels is achieved (warmth in the chest), while also avoiding the sensory deficits previously associated with higher nicotine levels (excessive harshness in the throat).

In some example embodiments, the acid generated during operation of the e-vaping device amounts to about 3.8568 μg/draw when the formulation includes about 3% glucose and substantially no sodium hydroxide or other added base. In other example embodiments, for a pre-vapor formulation having a concentration of sodium hydroxide of about 1%, the total acid generated during operation of the e-vaping device amounts to about 1.82 μg/draw when the glucose concentration is about 3%, about 1.37 μg/draw when the glucose concentration is about 2%, and about 0.75 μg/draw when the glucose concentration is about 1%.

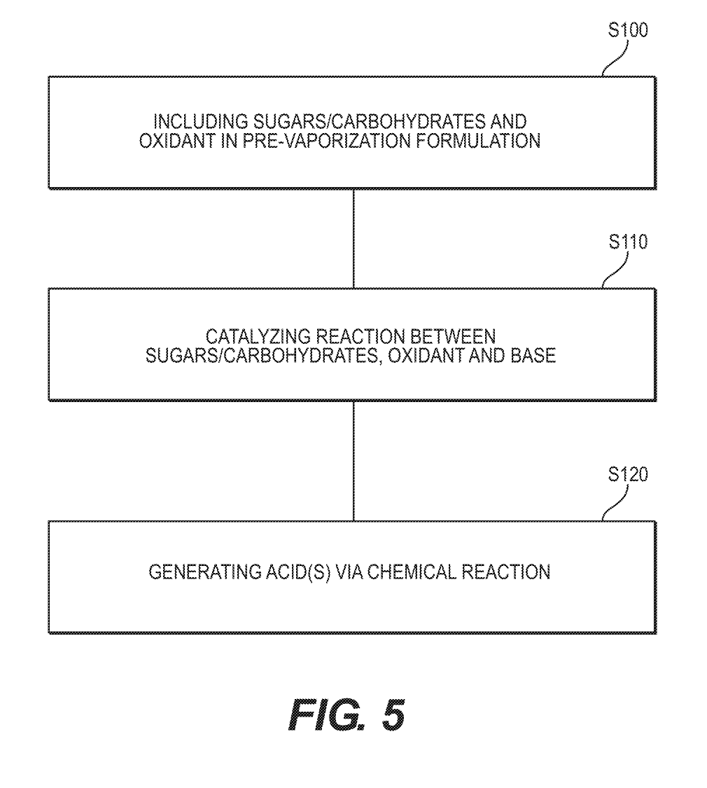

FIG. 5 is a flow chart illustrating a method of increasing stability of the ingredients of a pre-vapor formulation of an e-vaping device, according to various example embodiments. In FIG. 5, the method starts at S100, wherein a pre-vapor formulation is prepared. In example embodiments, the pre-vapor formulation is prepared by mixing a vapor former, nicotine, and at least one of sugars and/or polysaccharide carbohydrates, at least one oxidant and at least one added base. For example, the sugars and/or polysaccharide carbohydrates include glucose, the vapor former includes a combination of glycerol and propylene glycol, the oxidant includes copper oxide, iron oxide and/or zinc oxide, and the added base includes at least one of sodium hydroxide, acetone, ammonia, calcium hydroxide, lithium hydroxide, potassium hydroxide, pyridine, and zinc hydroxide. In S110, during operation of the e-vaping device, the pre-vapor formulation is heated, thus catalyzing a reaction between the at least one of one or more sugars and/or polysaccharide carbohydrates, the at least one oxidant and the at least one added base. In S120, as a result of the above-discussed reaction, one or more acids are generated. In example embodiment, the one or more acids include organic acids, and may reduce gas phase nicotine and reduce transfer efficiency of the nicotine from the particulate phase of the pre-vapor formulation to the vapor phase.

In example embodiments, mixing the at least one of one or more sugars and/or polysaccharide carbohydrates in the pre-vapor formulation includes mixing at least one of fructose, glucose, cellulose, maltose and xylose. Also, mixing the oxidant may include mixing a metal oxide such as, for example, copper oxide. In addition, mixing the base includes mixing at least one of sodium hydroxide, acetone, ammonia, calcium hydroxide, lithium hydroxide, potassium hydroxide, pyridine, and zinc hydroxide.

In example embodiments, a concentration of the nicotine in the vapor phase of the pre-vapor formulation is equal to or smaller than substantially 1% by weight. Also in example embodiments, generating the one or more acids via the reaction with the sugars and/or polysaccharide carbohydrates includes generating at least one of formic acid, oxalic acid, glycolic acid, acetic acid, isovaleric acid, valeric acid, propionic acid, octanoic acid, lactic acid, sorbic acid, malic acid, tartaric acid, succinic acid, citric acid, benzoic acid, oleic acid, aconitic acid, butyric acid, cinnamic acid, decanoic acid, 3,7-dimethyl-6-octenoic acid, 1-glutamic acid, heptanoic acid, hexanoic acid, 3-hexenoic acid, trans-2-hexenoic acid, isobutyric acid, lauric acid, 2-methylbutyric acid, 2-methylvaleric acid, myristic acid, nonanoic acid, palmitic acid, 4-pentenoic acid, phenylacetic acid, 3-phenylpropionic acid, hydrochloric acid, phosphoric acid and sulfuric acid.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

1. A pre-vapor formulation of an e-vaping device, the pre-vapor formulation comprising:
nicotine;
at least one of a sugar and a polysaccharide carbohydrate;
at least one oxidant;
at least one added base; and
a vapor former configured to form a vapor.

2. The pre-vapor formulation of claim 1, wherein the at least one sugar comprises sugar including at least one of fructose, glucose, galactose, maltose and xylose.

3. The pre-vapor formulation of claim 1, wherein a concentration of the at least one sugar is between about 1% and about 30% by weight.

4. The pre-vapor formulation of claim 1, wherein the at least one polysaccharide carbohydrate includes at least one of starch, cellulose and pectin.

5. The pre-vapor formulation of claim 1, wherein a concentration of the polysaccharide carbohydrate is 1% to 10% by weight.

6. The pre-vapor formulation of claim 1, wherein the at least one oxidant comprises a metal oxide.

7. The pre-vapor formulation of claim 6, wherein the metal oxide comprises at least one of copper oxide, zinc oxide and iron oxide.

8. The pre-vapor formulation of claim 1, wherein the at least one added base comprises at least one of sodium hydroxide, acetone, ammonia, calcium hydroxide, lithium hydroxide, potassium hydroxide, pyridine, and zinc hydroxide.

9. The pre-vapor formulation of claim 1, wherein the at least one carbohydrate, the at least one oxidant, and the at least one added base are configured to react by heating of the pre-vapor formulation during operation of the e-vaping device.

10. The pre-vapor formulation of claim 9, wherein one or more acids are generated via a reaction between the at least one carbohydrate, the at least one oxidant, and the at least one added base.

11. The pre-vapor formulation of claim 10, wherein the pH of the pre-vapor formulation is between about 4 and about 6.

12. The pre-vapor formulation of claim 10, wherein the generated one or more acids comprise at least one of formic acid, oxalic acid, glycolic acid, acetic acid, isovaleric acid, valeric acid, propionic acid, octanoic acid, lactic acid, sorbic acid, malic acid, tartaric acid, succinic acid, citric acid, benzoic acid, oleic acid, aconitic acid, butyric acid, cinnamic acid, decanoic acid, 3,7-dimethyl-6-octenoic acid, 1-glutamic acid, heptanoic acid, hexanoic acid, 3-hexenoic acid, trans-2-hexenoic acid, isobutyric acid, lauric acid, 2-methylbutyric acid, 2-methylvaleric acid, myristic acid, nonanoic acid, palmitic acid, 4-pentenoic acid, phenylacetic acid, 3-phenylpropionic acid, hydrochloric acid, phosphoric acid and sulfuric acid.

13. The pre-vapor formulation of claim 1, wherein a concentration of the nicotine in a vapor phase of the pre-vapor formulation is equal to or smaller than substantially 1% by weight.

14. A method of increasing stability of ingredients of a pre-vapor formulation of an e-vaping device, the method comprising:
preparing the pre-vapor formulation by mixing a vapor former, nicotine, at least one of one or more sugars and one or more polysaccharide carbohydrates, at least one oxidant and at least one added base;
during operation of the e-vaping device, catalyzing a reaction between the at least one of one or more sugars and one or more polysaccharide carbohydrates, the at least one oxidant and the at least one added base; and
generating at least one or more acids as a result of the catalyzed reaction.

15. The method of claim 14, wherein the reaction is catalyzed by the heating temperature of the pre-vapor formulation.

16. The method of claim 15, wherein the heating temperature is between about 150° C. and about 350° C.

17. The method of claim 14, wherein the mixing the at least one carbohydrate comprises mixing at least one of a sugar and a polysaccharide carbohydrate.

18. The method of claim 14, wherein:
the mixing the at least one of one or more sugars and one or more polysaccharide carbohydrates includes mixing at least one of fructose, glucose, cellulose, maltose and xylose;
the mixing the oxidant includes mixing a metal oxide; and
the mixing the at least one added base includes mixing at least one of sodium hydroxide, acetone, ammonia, calcium hydroxide, lithium hydroxide, potassium hydroxide, pyridine, and zinc hydroxide.

19. The method of claim 17, wherein the mixing the metal oxide comprises mixing at least one of copper oxide, zinc oxide and iron oxide.

20. The method of claim 14, wherein the generating comprises generating at least one of formic acid, oxalic acid, glycolic acid, acetic acid, isovaleric acid, valeric acid, propionic acid, octanoic acid, lactic acid, sorbic acid, malic acid, tartaric acid, succinic acid, citric acid, benzoic acid, oleic acid, aconitic acid, butyric acid, cinnamic acid, decanoic acid, 3,7-dimethyl-6-octenoic acid, 1-glutamic acid, heptanoic acid, hexanoic acid, 3-hexenoic acid, trans-2-hexenoic acid, isobutyric acid, lauric acid, 2-methylbutyric acid, 2-methylvaleric acid, myristic acid, nonanoic acid, palmitic acid, 4-pentenoic acid, phenylacetic acid, 3-phenylpropionic acid, hydrochloric acid, phosphoric acid and sulfuric acid.
